(19) United States
(12) Patent Application Publication
(10) Pub. No.: US 2008/0165114 A1
(43) Pub. Date: Jul. 10, 2008

(54) LCD BACKLIGHT DRIVING DEVICE WITH AN ISOLATING TRANSFORMER

(75) Inventors: Cheng-Chia Hsu, Chupei City (TW); Yu-Cheng Pan, Miaoli County (TW); Ho-Wen Chen, Taipei County (TW)

Correspondence Address: PAI PATENT & TRADEMARK LAW FIRM, 1001 FOURTH AVENUE, SUITE 3200, SEATTLE, WA, 98154, US

(73) Assignee: LOGAH TECHNOLOGY CORP., Chupei City (TW)

(21) Appl. No.: 11/621,922

(22) Filed: Jan. 10, 2007

(51) Int. Cl. G09G 3/36

(52) U.S. Cl. 345/102

(57) ABSTRACT

An LCD backlight driving device with an isolating transformer comprises a DC power supply, a square wave generator, a square wave controller, said isolating transformer and a driver transformer; wherein said isolating transformer has a primary side connected to said square wave generator and a secondary side connected to said driver transformer. Since said isolating transformer is placed between said square wave generator and said driver transformer, it effectively shortens a safety distance required for setting up said driver transformer, as compared to when said driver transformer is used directly; as a result, the area for implementing a circuit board is decreased and the manufacturing cost of said device is reduced.

### BACKGROUND OF THE INVENTION

1. Field of the Invention

The present invention relates to an LCD backlight driving device with an isolating transformer and more particularly to an LCD backlight driving device using an isolating transformer to reduce the manufacturing cost of the LCD backlight driving device.

2. Description of the Prior Art

Please refer to FIG. 1 for an implementation of a prior-art LCD backlight driving device. In FIG. 1, a prior-art LCD backlight driving device 1 uses a driver transformer 11 to boost the AC signal from 400V at the primary side to 1200V at the secondary side to drive a lamp 12. However, in order to comply with the safety distance requirement, the driver transformer 11 must have a spacing of at least 18 mm between its primary side and secondary side. Suppose one driver transformer 11 is used to drive one lamp 12, then the area of the driving circuit board comprising a plurality of driver transformers 11 will be significantly large and the manufacturing cost will be raised.

Therefore, the above-mentioned implementation of a prior-art LCD backlight driving device presents several shortcomings.

In view of the above-described deficiencies of prior-art LCD backlight driving device, after years of constant effort in research, the inventors of this invention have consequently developed and proposed an LCD backlight driving device with an isolating transformer in the present invention.

### SUMMARY OF THE INVENTION

It is an object of the present invention to provide an LCD backlight driving device with an isolating transformer to effectively shorten the safety distance required in implementing the driver transformer and to further reduce the area of the circuit board and to cut the manufacturing cost of the device.

It is another object of the present invention to provide an LCD backlight driving device with an isolating transformer to improve the stability in using the device, to extend the product lifetime, to cut back the transformer size and to save space.

The LCD backlight driving device with an isolating transformer of the present invention comprises a DC power supply, a square wave generator, a square wave controller, said isolating transformer and a driver transformer; wherein said isolating transformer has a primary side connected to said square wave generator and a secondary side connected to said driver transformer. Since said isolating transformer is placed between said square wave generator and said driver transformer, it effectively shortens a safety distance required for setting up said driver transformer, as compared to when said driver transformer is used directly; as a result, the area for implementing a circuit board is decreased and the manufacturing cost of said device is reduced.

These features and advantages of the present invention will be fully understood and appreciated from the following detailed description of the accompanying Drawings.

### BRIEF DESCRIPTION OF THE DRAWINGS

FIG. 1 illustrates an implementation of a prior-art LCD backlight driving device;

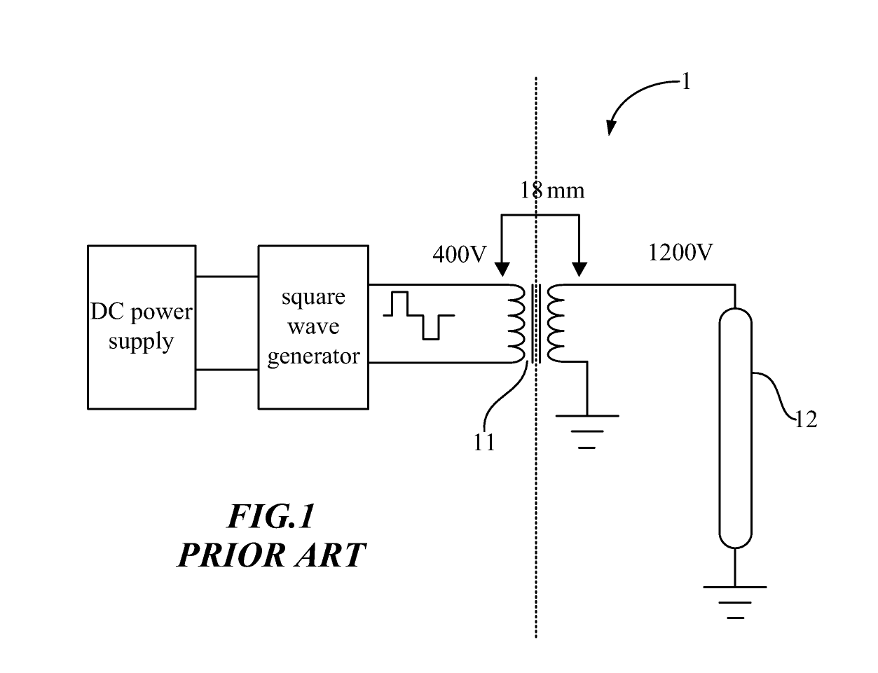

FIG. 2 illustrates a first embodiment of an LCD backlight driving device with an isolating transformer disclosed in the present invention;

FIG. 3 illustrates a second embodiment of an LCD backlight driving device with an isolating transformer disclosed in the present invention; and

FIG. 4 illustrates a third embodiment of an LCD backlight driving device with an isolating transformer disclosed in the present invention.

### DETAILED DESCRIPTION OF THE PREFERRED EMBODIMENTS

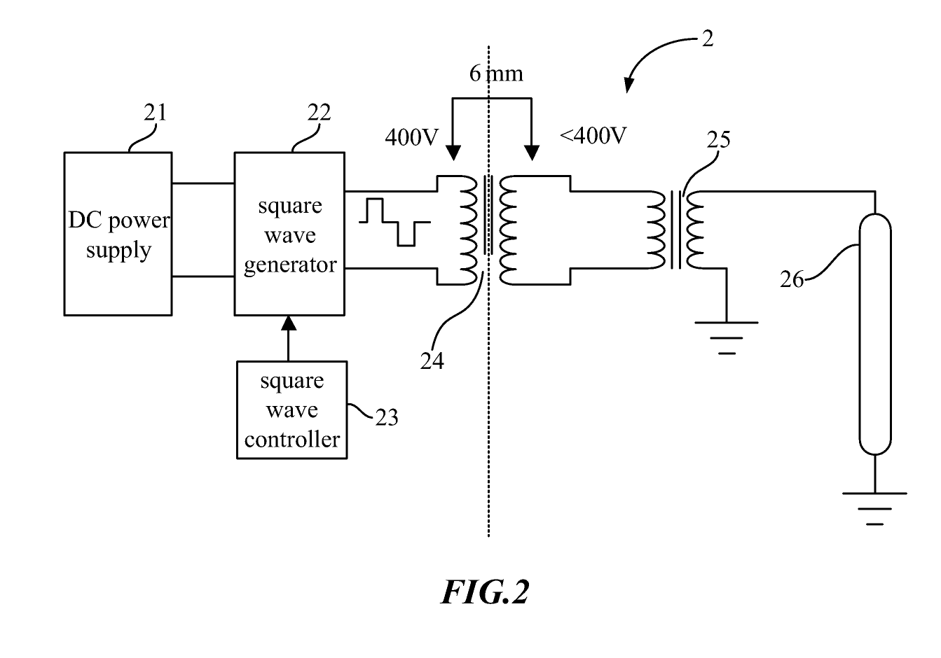

Please refer to FIG. 2, which illustrates a first embodiment of an LCD backlight driving device with an isolating transformer disclosed in the present invention. From the figure, an LCD backlight driving device with an isolating transformer 2 comprises:

a DC power supply 21 for outputting a DC signal to a square wave generator 22;

the square wave generator 22 for converting the DC signal into an AC signal and outputting the AC signal to a primary side of a isolating transformer 24;

a square wave controller 23 for outputting a control signal to the square wave generator 22;

the isolating transformer 24 for receiving the AC signal from the square wave generator 22, and then outputting the AC signal, from a secondary side of the isolating transformer 24, to a primary side of a driver transformer 25; and

the driver transformer 25 for boosting the AC signal inputted from the isolating transformer 24, and then outputting a boosted AC signal, from a secondary side of the driver transformer 25, to a lamp 26.

For an input voltage of 400V at the primary side of the isolating transformer 24, an output voltage at the secondary side of the isolating transformer 24 will be less than 400V. Therefore the safety spacing between the primary side and the secondary side of the isolating transformer 24 is only 6 mm. Thus, the isolating transformer effectively shortens the safety distance required, as compared to when said driver transformer is used directly; as a result, the area for implementing a circuit board is decreased and the manufacturing cost of the device is reduced.

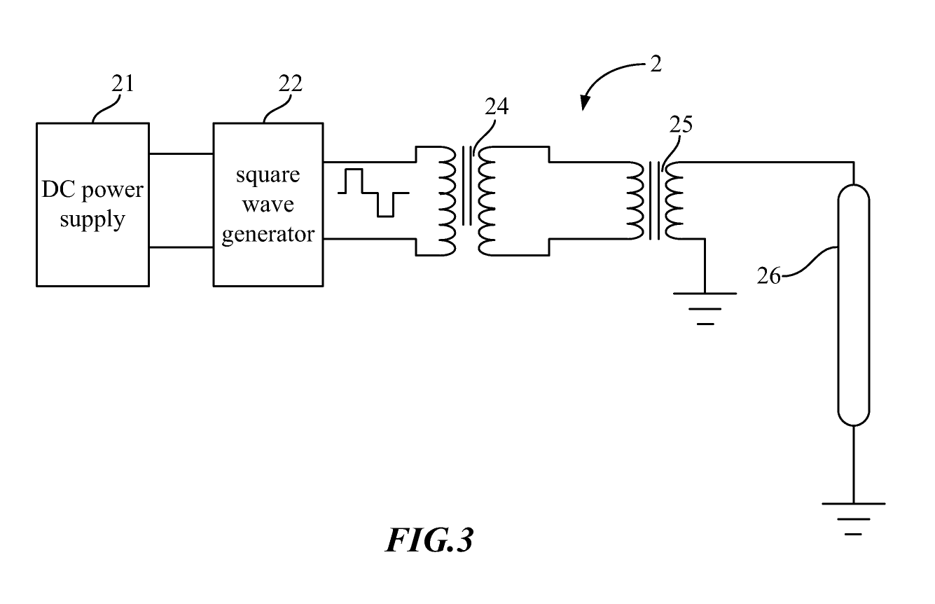

Please refer to FIG. 3, which illustrates a second embodiment of an LCD backlight driving device with an isolating transformer disclosed in the present invention. From the figure, an LCD backlight driving device with an isolating transformer 2 comprises:

a DC power supply 21 for outputting a DC signal to a square wave generator 22;

the square wave generator 22 for converting the DC signal into an AC signal and outputting the AC signal to a primary side of a isolating transformer 24;

the isolating transformer 24 for receiving the AC signal from the square wave generator 22, and then outputting the AC signal, from a secondary side of the isolating transformer 24, to a primary side of a driver transformer 25; and

the driver transformer 25 for boosting the AC signal inputted from the isolating transformer 24, and then outputting a boosted AC signal, from a secondary side of the driver transformer 25, to a lamp 26.

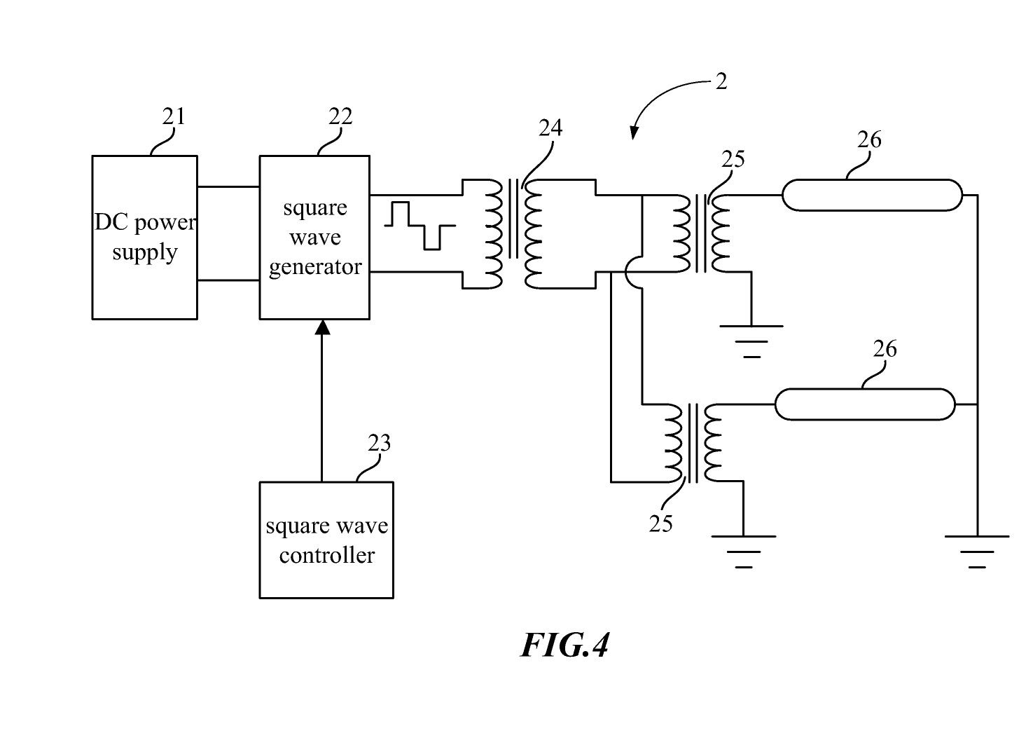

Please refer to FIG. 4, which illustrates a third embodiment of an LCD backlight driving device with an isolating transformer disclosed in the present invention. From the figure, an LCD backlight driving device with an isolating transformer 2 comprises:

a DC power supply 21 for outputting a DC signal to a square wave generator 22;

the square wave generator 22 for converting the DC signal into an AC signal and outputting the AC signal to a primary side of the isolating transformer 24;

a square wave controller 23 for outputting a control signal to the square wave generator 22;

the isolating transformer 24 for receiving the AC signal from the square wave generator 22, and then outputting the AC signal, from a secondary side of the isolating transformer 24, to primary sides of a plurality of driver transformers 25; and

the plurality of driver transformers 25 for boosting the AC signal inputted from the isolating transformer 24, and then outputting the boosted AC signal, from secondary sides of the plurality of driver transformers 25, to a plurality of lamps.

In the embodiments of the present invention, the isolating transformer 24 can have a capacitor implemented at its primary side or secondary side to prevent interference of a DC current.

The present invention discloses an LCD backlight driving device with an isolating transformer which, while compared with conventional techniques, is advantageous in the following respects:

1. The present invention provides an LCD backlight driving device with an isolating transformer to effectively shorten the safety distance required for implementing the driver transformer and to further reduce the area of the circuit board and to cut the manufacturing cost of the device.

2. The present invention provides an LCD backlight driving device with an isolating transformer to improve the stability in using the device, to extend the product lifetime, to cut back the transformer size and to save space.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An LCD backlight driving device with an isolating transformer, comprising:
a DC power supply for outputting a DC signal to a square wave generator;
said square wave generator for converting said DC signal into an AC signal and outputting said AC signal to a primary side of said isolating transformer;
a square wave controller for outputting a control signal to said square wave generator;
said isolating transformer for receiving said AC signal from said square wave generator, and then outputting said AC signal, from a secondary side of said isolating transformer, to a primary side of a driver transformer; and
said driver transformer for boosting said AC signal inputted from said isolating transformer, and then outputting a boosted AC signal, from a secondary side of said driver transformer, to a lamp.

2. The LCD backlight driving device with an isolating transformer of claim 1, wherein said isolating transformer has a capacitor implemented at its primary side or secondary side.

3. An LCD backlight driving device with isolating transformer, comprising:
a DC power supply for outputting a DC signal to a square wave generator;
said square wave generator for converting said DC signal into an AC signal and outputting said AC signal to a primary side of said isolating transformer;
said isolating transformer for receiving said AC signal from said square wave generator, and then outputting said AC signal, from a secondary side of said isolating transformer, to a primary side of a driver transformer; and
said driver transformer for boosting said AC signal inputted from said isolating transformer, and then outputting a boosted AC signal, from a secondary side of said driver transformer, to a lamp.

4. The LCD backlight driving device with an isolating transformer of claim 3, wherein said isolating transformer has a capacitor implemented at its primary side or secondary side.

5. An LCD backlight driving device with isolating transformer, comprising:
a DC power supply for outputting a DC signal to a square wave generator;
said square wave generator for converting said DC signal into an AC signal and outputting said AC signal to a primary side of said isolating transformer;
a square wave controller for outputting a control signal to said square wave generator;
said isolating transformer for receiving said AC signal from said square wave generator, and then outputting said AC signal, from a secondary side of said isolating transformer, to primary sides of a plurality of driver transformers; and
said plurality of driver transformers for boosting said AC signal inputted by said isolating transformer, and then outputting said boosted AC signal, from secondary sides of said plurality of driver transformers, to a plurality of lamps.

6. The LCD backlight driving device with an isolating transformer of claim 5, wherein said isolating transformer has a capacitor implemented at its primary side or secondary side.
